(19) United States
(12) Patent Application Publication
(10) Pub. No.: US 2010/0149175 A1
(43) Pub. Date: Jun. 17, 2010

(54) 3D ENHANCEMENT OF VIDEO REPLAY

(75) Inventor: Leong Tan, Campbell, CA (US)

Correspondence Address: NVIDIA C/O MURABITO, HAO & BARNES LLP, TWO NORTH MARKET STREET, THIRD FLOOR, SAN JOSE, CA, 95113, US

(73) Assignee: NVIDIA CORPORATION, Santa Clara, CA (US)

(21) Appl. No.: 12/335,259

(22) Filed: Dec. 15, 2008

(51) Int. Cl. G06T 15/00

(52) U.S. Cl. 345/419

(57) ABSTRACT

A method for 3-D enhancement of video playback. The method includes receiving a plurality of video streams from a corresponding plurality of video capture devices and processing image data comprising each of the video streams using a 3-D surface reconstruction algorithm to create a 3-D surface map representative of the image data. The 3-D surface map is manipulated to create a virtual camera position. Video is then rendered in accordance with the 3-D surface map and in accordance with the virtual camera position.

### FIELD OF THE INVENTION

The present invention is generally related to hardware accelerated graphics computer systems.

### BACKGROUND OF THE INVENTION

Instant replay is a technology that allows broadcast of a previously occurring event using recorded video. This is most commonly used in sports. For example, most sports enthusiasts are familiar with televised sporting events where, during the course of a game, one or more replays of a previously occurring play is televised for the audience. The replays are often from different camera angles than the angle shown in the main broadcast. The replay footage is often played at a slow motion frame rate to allow more detailed analysis by the viewing audience and event commentators. More advanced technology has allowed for more complex replays, such as pausing, and viewing the replay frame by frame.

The problem with the present instant replay technology is the fact that although a number of different camera angles and a number of different slow-motion frame rates may be available, the selection of which particular replay to select and the selection of which particular camera angle will be shown in the main broadcast is limited. For example, although multiple cameras may be used to record a given sporting event, the number of replay angles is directly related to the number of cameras. If five replay angles are desired, then five cameras must be utilized. If seven replay angles are desired, then seven cameras must be utilized, and so on. Another limitation involves the fact that even though a number of different replay angles are available, there is no ability to customize which angle is made available to a commentator. If seven cameras are used, the selected replay will be from one of the seven. With regard to the user at home receiving the broadcast, there is no user control of which angle will be shown.

Thus, what is needed is a method for improving the flexibility and control of video playback from multiple video sources and from multiple video playback angles.

### SUMMARY OF THE INVENTION

Embodiments of the present invention provide a method for improving the flexibility and control of video playback from multiple video sources and from multiple video playback angles.

In one embodiment, the present invention comprises a computer implemented method for 3-D enhancement of video playback. The method includes receiving a plurality of video streams from a corresponding plurality of video capture devices (e.g., multiple video cameras distributed at different locations). The image data comprising each of the video streams (e.g., 30 frames per second real-time video, etc.) is then processed using a 3-D surface reconstruction algorithm to create a 3-D surface map representative of the image data. The 3-D surface map is manipulated to create a virtual camera position. The virtual camera position can have its own virtual location and its own virtual viewing angle. Video is then rendered in accordance with the 3-D surface map and in accordance with the virtual camera position.

In one embodiment, the 3-D surface map is manipulated using a distributed multi-node computer system apparatus (e.g., multiple computer system nodes coupled via a high-speed network). The distributed computer system can be housed at, for example, a broadcast facility and the video can be transmitted to a plurality of receivers via a broadcast system (e.g., terrestrial broadcast, satellite broadcast, etc.).

Alternatively, in one embodiment, the 3-D surface map can be transmitted to a receiver (e.g., at a user location) and can be manipulated using a computer system at the user location. The video is then replayed to a local display coupled to the computer system.

In one embodiment, the 3-D surface map can be preprocessed to produce a reduced complexity 3-D surface map. This reduced complexity 3-D surface map is then transmitted to a handheld device and is manipulated using an embedded computer system of the handheld device, and wherein the video is replayed to a display of the handheld device. The reduced complexity 3-D surface map is thus tailored to deliver better performance on the handheld device.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a computer system in accordance with one embodiment of the present invention.

FIG. 2 shows an overview diagram illustrating the steps of a process 200 and accordance with one embodiment of the present invention.

FIG. 3 shows an exemplary arena and multiple video cameras distributed at different locations around the periphery of the arena to capture real-time video along their specific line of sight in accordance with one embodiment of the present invention.

FIG. 4 shows a diagram of a number of different virtual camera angles in accordance with one embodiment of the present invention.

FIG. 5 shows a diagram illustrating a multi-node distributed computer system apparatus in accordance with one embodiment of the present invention.

### DETAILED DESCRIPTION OF THE INVENTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the embodiments of the present invention.

### Notation and Nomenclature:

Some portions of the detailed descriptions, which follow, are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

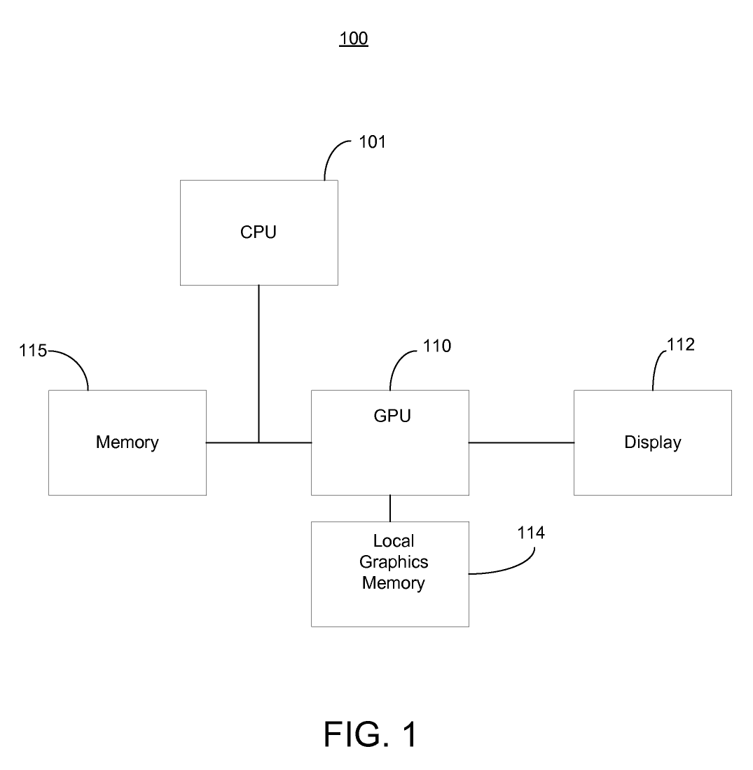

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system (e.g., computer system 100 of FIG. 1), or similar electronic computing device, that manipulates and transforms data represented as physical (electronic) quantities within the computer system's computer readable media, registers and memories into other data similarly represented as physical quantities within the computer system memories or registers or other such information storage, transmission or display devices.

### Computer System Platform:

FIG. 1 shows a computer system 100 in accordance with one embodiment of the present invention. Computer system 100 depicts the components of a basic computer system in accordance with embodiments of the present invention providing the execution platform for certain hardware-based and software-based functionality. In general, computer system 100 comprises at least one CPU 101, a system memory 115, and at least one graphics processor unit (GPU) 110. The CPU 101 can be coupled to the system memory 115 via a bridge component/memory controller (not shown) or can be directly coupled to the system memory 115 via a memory controller (not shown) internal to the CPU 101. The GPU 110 is coupled to a display 112. One or more additional GPUs can optionally be coupled to system 100 to further increase its computational power. The GPU(s) 110 is coupled to the CPU 101 and the system memory 115. System 100 can be implemented as, for example, a desktop computer system or server computer system, having a powerful general-purpose CPU 101 coupled to a dedicated graphics rendering GPU 110. In such an embodiment, components can be included that add peripheral buses, specialized graphics memory, IO devices, and the like. Similarly, system 100 can be implemented as a handheld device (e.g., cellphone, etc.) or a set-top video game console device such as, for example, the Xbox®, available from Microsoft Corporation of Redmond, Wash., or the PlayStation3®, available from Sony Computer Entertainment Corporation of Tokyo, Japan.

It should be appreciated that the GPU 110 can be implemented as a discrete component, a discrete graphics card designed to couple to the computer system 100 via a connector (e.g., AGP slot, PCI-Express slot, etc.), a discrete integrated circuit die (e.g., mounted directly on a motherboard), or as an integrated GPU included within the integrated circuit die of a computer system chipset component (not shown). Additionally, a local graphics memory 114 can be included for the GPU 110 for high bandwidth graphics data storage.

### EMBODIMENTS OF THE INVENTION

Embodiments of the present invention implement methods and systems for improving the flexibility and control of video playback from multiple video sources and from multiple video playback angles. In one embodiment, the present invention comprises a computer implemented method (e.g., by computer system 100) for 3-D enhancement of video playback. The method includes receiving a plurality of video streams from a corresponding plurality of video capture devices (e.g., multiple video cameras distributed at different locations) and processing image data comprising each of the video streams (e.g., 30 frames per second real-time video, etc.) using a 3-D surface reconstruction algorithm to create a 3-D surface map representative of the image data. The 3-D surface map is manipulated to create a virtual camera position. Video is then rendered in accordance with the 3-D surface map and in accordance with the virtual camera position. Embodiments of the present invention and their benefits are further described below.

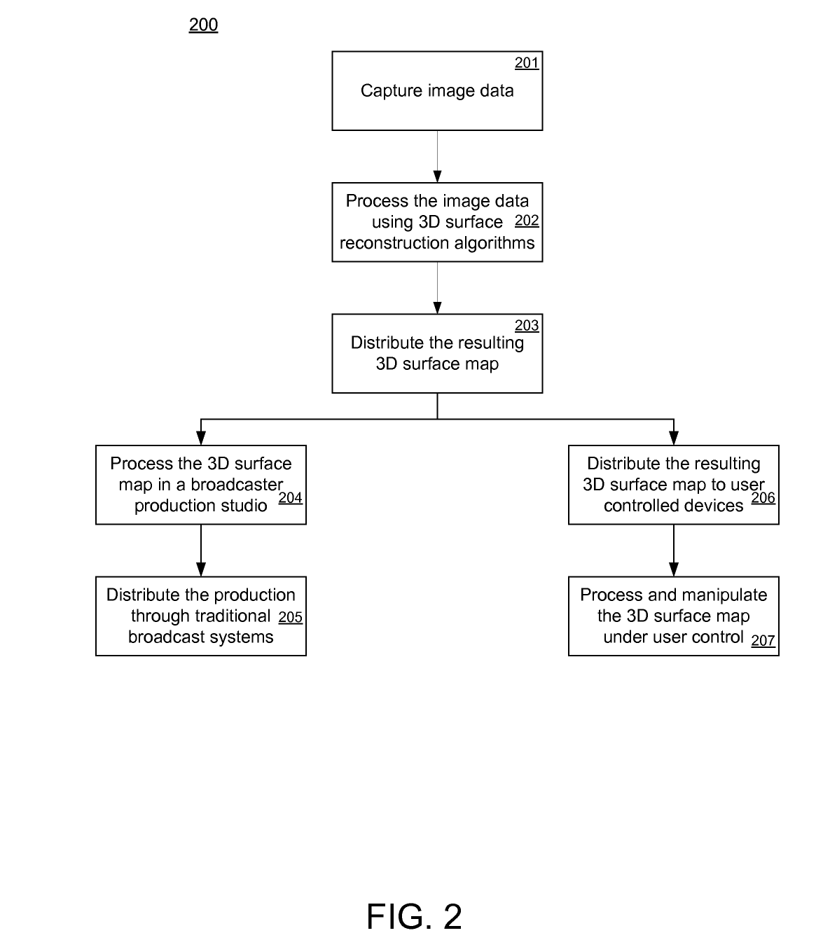

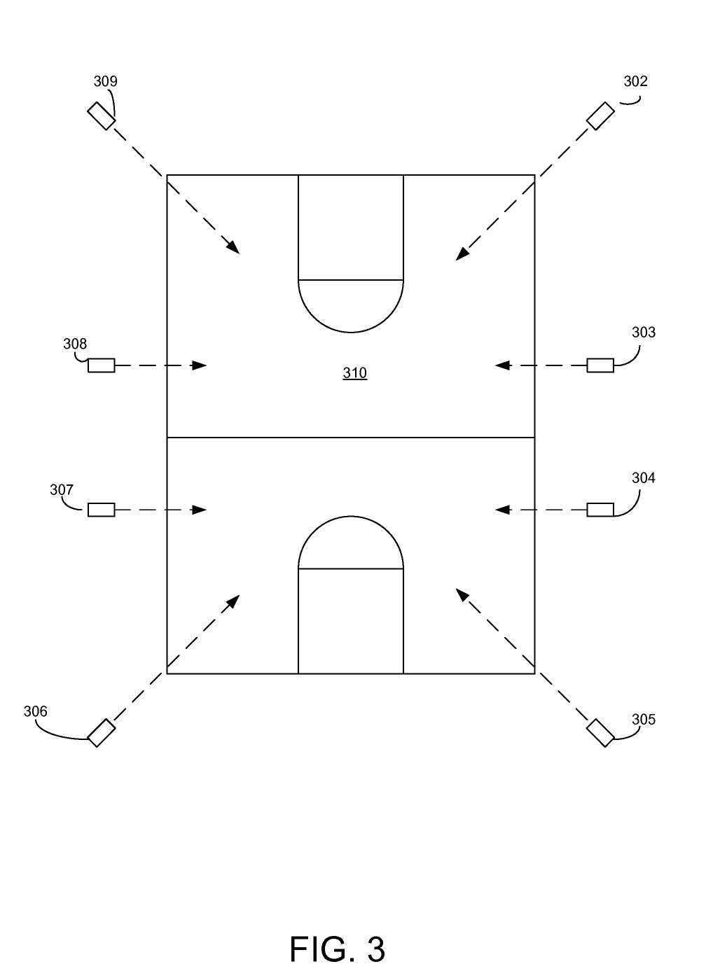

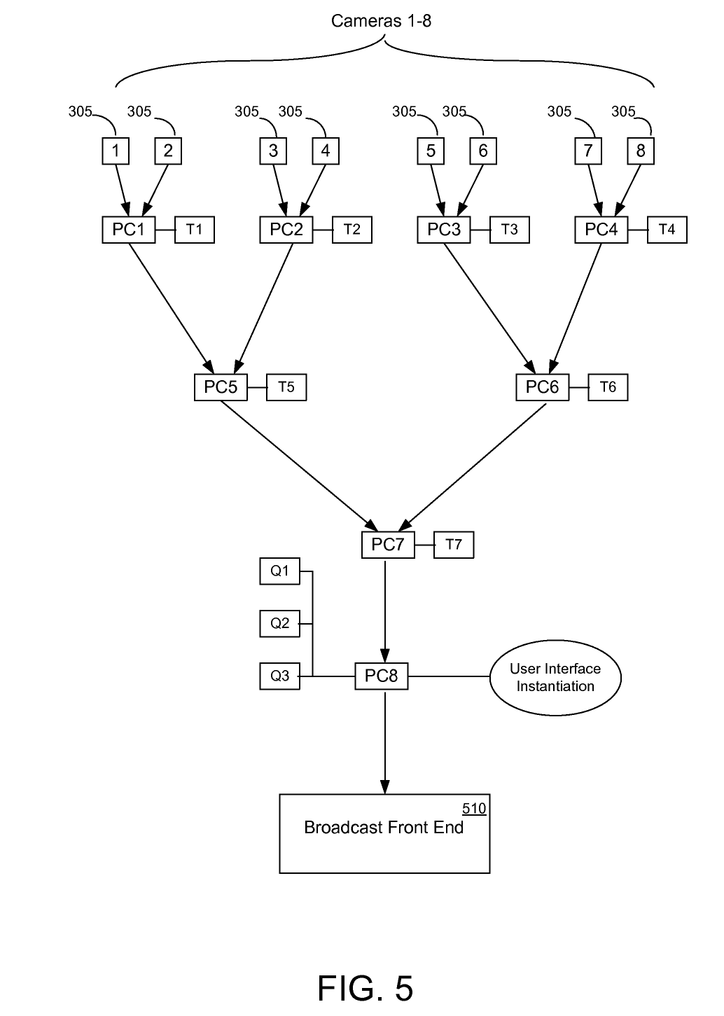

FIG. 2 shows an overview diagram illustrating the steps of a process 200 and accordance with one embodiment of the present invention. As depicted in FIG. 2, process 200 shows the operating steps of a 3-D enhancement of video playback method. The steps of the process 200 will now be described in the context of computer system 100 of FIG. 1, the multiple cameras 301-308 FIG. 3, the virtual camera angles 401-403, and the multi-node distributed computer system apparatus 500 of FIG. 5.

Process 200 begins and step 201, where image data is captured and received by the processing system. The captured image data is typically image data from a plurality of video streams from a corresponding plurality of video capture devices. For example, FIG. 3 shows a basketball arena 310 and multiple video cameras 301-308 distributed at different locations around the periphery of the arena to capture real-time video along their specific lines of sight. Each camera's line of sight is illustrated in FIG. 3 by a dotted line, as shown. As real-time video is received by each of the cameras 301-308, the resulting video screen is digitized and the resulting image data is transmitted to and captured by the processing system.

It should be noted that although eight cameras are depicted in FIG. 3, the image data capture step 201 can be adapted to utilize image data from a larger number of cameras (e.g., 16, 32, or more) or a fewer number of cameras (e.g., 4, 2, or even one).

In step 202, the image data received from the image capture devices (e.g., the cameras 301-308) is processed using a 3-D surface reconstruction algorithm to create a 3-D surface map representative of the image data. Step 202 depends upon the heavily compute intensive workload incurred by executing the 3-D surface reconstruction algorithm.

In general, the 3-D surface reconstruction algorithm functions by reconstructing 3D surface points and a wireframe on the surface of a number of freeform objects comprising the scene. In the FIG. 3 example, these objects would be the basketball court 310 itself, the players, the basketball, and the like. The image data from the cameras 301-300 and are taken at different respective viewing locations and directions as shown by FIG. 3. The 3-D surface reconstruction algorithm takes advantage of the fact that each camera's perspective, orientation, and image capture specifications are known. This knowledge enables the algorithm to locate and accurately 3D place reconstructed surface points and a wireframe network of contour generators. The image data output from each of the cameras 301-308 is fed into the algorithm's reconstruction engine. The engine maps every pixel of information and triangulates the location of the objects of the scene by triangulating where the various camera images intersect. The finished result is a high-resolution surface model that represents both the geometry and the reflectance properties (e.g., color, texture, brightness, etc.) of the various surfaces of the various objects comprising the scene.

In step 203, the resulting 3-D surface map is distributed to viewpoint manipulation systems in order to generate the desired virtual camera angle for viewing the scene. For example, process 200 shows two branches for distributing the 3-D surface map. As shown by steps 204 and 205, the 3-D surface map can be distributed to a location housing a high-performance computer system.

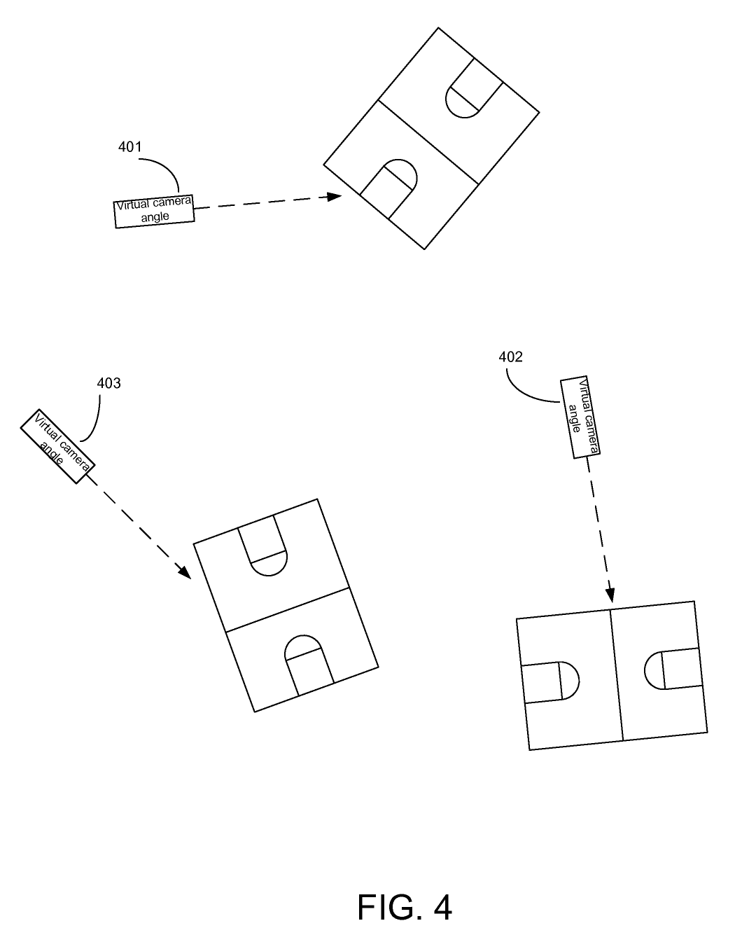

In step 204, the 3-D surface map is processed in a broadcast or production studio. This studio is equipped with a high-performance computer system that is specifically adapted to manipulate highly complex 3-D surface maps and generate multiple virtual camera angles in real time. Computer system 500 of FIG. 5 shows an example of such a system. For example, in a typical scenario, a number of different virtual camera angles 401-403 shown in FIG. 4 can be determined under the direction of the broadcast commentator. The different virtual camera angles can be selected to show particular aspects of game play, particular calls by a referee or an official, show particular means of teammate interaction, or the like. The imagination of the broadcast commentator would yield a plethora of different selections and orientations of the virtual camera angles.

Subsequently, in step 205, the resulting video stream is distributed through the traditional broadcast systems. The resulting video stream will be either one of the selected real camera angles or one of the selected virtual camera angle as determined by the broadcast commentator, producer, or the like.

Alternatively, steps 206 and 207 show a different mechanism of control for process 200. In step 206, the 3-D surface map is distributed to a number of different user control devices. The distribution can be via terrestrial broadcast, satellite broadcast, or the like. Instead of sending a traditional video stream broadcast, the resulting 3-D surface map can also be transmitted to user controlled devices.

In one embodiment, the device is a set-top box or a desktop or home server computer system. Such a system would typically include a sufficiently powerful CPU and GPU to execute the demanding 3-D surface map manipulation routines. The resulting playback would occur on a local display coupled to the user's desktop machine, set-top box, home server, etc.

In step 207, the 3-D surface map is processed and manipulated under the user's control. The user can for example, drag and drop the virtual camera angle using a GUI and then initiate playback from the virtual camera angle. This places control of the playback, playback location, playback camera angle, playback speed, and the like in the hands of the user himself. The user can determine where the virtual camera angle will be.

In one embodiment, the 3-D surface map can be preprocessed to produce a reduced complexity 3-D surface map. This reduced complexity 3-D surface map is then transmitted to a handheld device and is manipulated using an embedded computer system of the handheld device. The video is thin replayed on a display of the handheld device. The reduced complexity 3-D surface map is thus tailored to deliver better performance on the comparatively limited computer resources of the handheld device.

Referring now to FIG. 5, system 500 is now described in greater detail. System 500 comprises a distributed computer system apparatus that is designed to process a large portion of the 3-D surface reconstruction algorithm in parallel. The workload associated with the algorithm is allocated across the machines of system 500 as efficiently as possible. As shown in FIG. 5, the image information from the cameras 301-308 are fed respectively into a first row of computer systems PC1, PC2, PC3, and PC4. Each of these machines incorporates a high-performance GPU subsystem, shown as T1, T2, T3, and T4 (e.g., Tesla™ GPU systems). The GPU subsystems are specifically configured to execute large amounts of the 3-D surface reconstruction algorithm workload. The resulting output from PC1, PC2, PC3, and PC4 are transmitted to second row machines PC5-T5 and PC6-T6, and the results of this further processing is transmitted to a bottom row machine PC7-T7.

At this point, the construction of the 3-D surface map is largely complete. The resulting 3-D surface map is then transmitted to the virtual camera manipulation machine PC8. This computer system instantiates the user interface where the broadcast director, producer, or the like manipulates the 3-D surface map and places the desired virtual camera angles. This machine is also different than the other machines in that it is shown as being connected to three specialized multi-GPU graphics subsystems Q1, Q2, and Q3 (e.g., QuadroPlex™ systems). As described above, once the virtual camera angles have been selected and rendered, the resulting video stream is transmitted to a broadcast front end 510 for distribution through the broadcast network.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for 3-D enhancement of video playback, comprising:
receiving a plurality of video streams from a corresponding plurality of video capture devices;
processing image data comprising each of the video streams using a 3-D surface reconstruction algorithm to create a 3-D surface map representative of the image data;
manipulating the 3-D surface map to create a virtual camera position; and
rendering video in accordance with the 3-D surface map and in accordance with the virtual camera position.

2. The method of claim 1, wherein the 3-D surface map is manipulated using a distributed computer system network and the video is transmitted to a plurality of receivers via a broadcast system.

3. The method of claim 1, wherein the 3-D surface map is transmitted to a receiver and is manipulated using a computer system, and wherein the video is replayed to a local display coupled to the computer system.

4. The method of claim 1, wherein the 3-D surface map is preprocessed to produce a reduced complexity 3-D surface map, and wherein the reduced complexity 3-D surface map is transmitted to a handheld device and is manipulated using an embedded computer system of the handheld device, and wherein the video is replayed to a display of the handheld device.

5. The method of claim 1, wherein the 3-D surface map is manipulated in real time to create a virtual camera position in real time.

6. The method of claim 1, wherein the 3-D surface map is manipulated in real time to create a virtual camera position in real time.

7. The method of claim 1, wherein the processing using the 3-D surface reconstruction algorithm is performed on a plurality of computer systems having a corresponding plurality of general-purpose enabled GPUs (graphics processing units).

8. An apparatus for 3-D enhancement of video playback, comprising:
a plurality of computer systems, each computer system having a CPU (central processing unit) and a GPU (graphics processing unit) and a computer readable memory, the computer readable memory storing computer readable code which when executed by each computer system causes the apparatus to:
receive a plurality of video streams from a corresponding plurality of video capture devices;
process image data comprising each of the video streams using a 3-D surface reconstruction algorithm to create a 3-D surface map representative of the image data;
manipulate the 3-D surface map to create a virtual camera position; and
render video in accordance with the 3-D surface map and in accordance with the virtual camera position.

9. The apparatus of claim 8, wherein the 3-D surface map is manipulated using a distributed computer system network and the video is transmitted to a plurality of receivers via a broadcast system.

10. The apparatus of claim 8, wherein the 3-D surface map is transmitted to a receiver and is manipulated using a computer system, and wherein the video is replayed to a local display coupled to the computer system.

11. The apparatus of claim 8, wherein the 3-D surface map is preprocessed to produce a reduced complexity 3-D surface map, and wherein the reduced complexity 3-D surface map is transmitted to a handheld device and is manipulated using an embedded computer system of the handheld device, and wherein the video is replayed to a display of the handheld device.

12. The apparatus of claim 8, wherein the 3-D surface map is manipulated in real time to create a virtual camera position in real time.

13. The apparatus of claim 8, wherein the 3-D surface map is manipulated in real time to create a virtual camera position in real time.

14. The apparatus of claim 8, wherein each of the computer systems is communicatively coupled via a network to exchange the image data and the 3-D surface reconstruction algorithm.

15. The apparatus of claim 14, wherein a load-balancing algorithm is implemented to distribute working from the 3-D surface reconstruction algorithm among the plurality of computer systems.

16. A computer readable media for a method for 3-D enhancement of video playback, the method implemented by a computer system having a CPU (central processing unit) and a GPU (graphics processing unit) and a computer readable memory, the computer readable memory storing computer readable code which when executed by each computer system causes the computer system to implement a method comprising:
receiving a plurality of video streams from a corresponding plurality of video capture devices;
processing image data comprising each of the video streams using a 3-D surface reconstruction algorithm to create a 3-D surface map representative of the image data;
manipulating the 3-D surface map to create a virtual camera position; and
rendering video in accordance with the 3-D surface map and in accordance with the virtual camera position.

17. The computer readable media of claim 16, wherein the 3-D surface map is manipulated using a distributed computer system network and the video is transmitted to a plurality of receivers via a broadcast system.

18. The computer readable media of claim 16, wherein the 3-D surface map is transmitted to a receiver and is manipulated using a computer system, and wherein the video is replayed to a local display coupled to the computer system.

19. The computer readable media of claim 16, wherein the 3-D surface map is preprocessed to produce a reduced complexity 3-D surface map, and wherein the reduced complexity 3-D surface map is transmitted to a handheld device and is manipulated using an embedded computer system of the handheld device, and wherein the video is replayed to a display of the handheld device.

20. The computer readable media of claim 16, wherein the 3-D surface map is manipulated in real time to create a virtual camera position in real time.
